(19) United States
(12) Patent Application Publication
(10) Pub. No.: US 2022/0334825 A1
(43) Pub. Date: Oct. 20, 2022

(54) MODULAR FIRMWARE UPDATE

(71) Applicants: Piotr K. Swirydczuk, Gdansk (PL); Sagar V. Dalvi, Hillsboro, OR (US)

(72) Inventors: Piotr K. Swirydczuk, Gdansk (PL); Sagar V. Dalvi, Hillsboro, OR (US)

(21) Appl. No.: 17/856,742

(22) Filed: Jul. 1, 2022

(51) Int. Cl. G06F 8/65; H04L 67/00

(52) U.S. Cl. CPC G06F 8/65; H04L 67/34

(57) ABSTRACT

An apparatus of a data center, a computer-readable medium, a method and a system. The apparatus includes one or more processors to: access first information corresponding to a firmware (FW) payload, the FW payload to identify a server FW component; access second information corresponding to FW update metadata, the FW update metadata to indicate one or more dependencies of a FW update of the server FW component; perform a validation of the one or more dependencies against corresponding server information; and in response to a determination of a success of the validation, communicate with an execution engine to cause execution of the FW update on the server.

### BACKGROUND

Server platforms in data centers contain many inter-dependent firmware components built into the platform (e.g., basis input/output system (BIOS), baseboard management controller (BMC), server platform services (SPS), system-on-a-chip, Power Supply), or hosted on devices plugged into the platform (e.g., persistent memory, network interface card (NIC), solid state device (SSD), etc.). To limit validation scope and ensure inter-operability, such firmwares (FWs) are updated together to a pre-validated firmware (FW) image package. Doing so allows verification based platform configuration and performance of a resilient Seamless Update of FW components. modular firmware component update requires a mechanism to generate, express and process inter-component dependencies at various phases of the firmware development, validation, and deployment process.

### BRIEF DESCRIPTION OF THE DRAWINGS

FIG. 1 depicts an example flow of phases of a modular FW update mechanism according to one embodiment.

FIG. 2 depicts an example flow of stages of a FW update capsule generation stage and of a FW update execution stage according to one embodiment.

FIG. 3 depicts an example configuration of a FW update capsule or package according to one embodiment.

FIG. 4 depicts a flow for generating a FW update capsule such as the FW update capsule of FIG. 3.

FIG. 5 depicts in schematic form an example computing system to be used to implement some embodiments.

FIG. 6 depicts in schematic form another example computing system to be used to implement some embodiments.

FIG. 7 depicts a process according to some embodiments.

### DETAILED DESCRIPTION

Some embodiments provide a mechanism to perform firmware (FW) component updates (or “FW updates”) when a server is “online,” that is, during runtime.

Some embodiments provide an apparatus of a data center, the apparatus including one or more processors to: access first information to identify a firmware (FW) component, the FW component on a server of the data center; access second information corresponding to FW update metadata on one or more dependencies of a FW update of the FW component; perform a validation of the one or more dependencies against corresponding information at the server; and in response to a determination of a success of the validation, communicate with the server to cause execution of an update of the FW component on the server.

Advantageously, some embodiments allow a modular update of FW components on a server, even during runtime.

In the following figures, like components will be referred to with like and/or the same reference numerals. Therefore, detailed description of such components may not be repeated from figure to figure.

For the purposes of the present disclosure, the term “data center” may, by way of example, refer to a plurality of computing components or computing units in a computing network, regardless of whether such components are in one physical location (e.g., one building), in multiple physical locations (e.g. in different buildings), and regardless of whether the network is a wired, wireless or hybrid wired and wireless network.

For the purposes of the present disclosure, the term “FW component” or “FW ingredient” may, by way of example, refer to an operating system (OS), kernel, device drivers, and/or application code associated with FW. Example FW components include microcode, manageability engine server services (ME SPS) FW, BIOS, system management mode (SMM) FW, or persistent memory (PMEM) FW, SSD FW, to name a few.

A server may, by way of example, include any number of systems and/or subsystems, respective ones of the latter including any number of computing units (e.g., CPUs) and any number of associated memory circuitries (e.g., caches) in any configuration. In addition, the use of a grid computing circuitry, such as a grid computing circuitry, or other similar grid computing technology is optional. A server may be implemented, by way of example, as logic on one or more hardware devices, where, if multiple hardware devices implement the server, they may be adapted to communicate with one another. A server may include a server platform, such as one or more systems or devices that implement server functionality.

A data center manager (DCM) may, by way of example, include functionality in the form of code, such as software, firmware or drivers that may be executed by one or more processors. A DCM may orchestrate data center operations among server platforms for management and updating of firmware applications and workloads being executed on server platforms, and do so without executing workloads. The one or more processors implementing a DCM may be in one physical location, or they may be physically disaggregated with respect to one another.

For the purposes of this disclosure, a “computing unit” includes any physical component, or logical arrangement of physical components, capable of implementing processing operations. Example computing units include, but are not limited to a CPU, a core, a CPU complex, a server complex, a field programmable gate array (FPGA), an ASIC, a graphics processing unit (GPU), or other co-processors.

A “memory circuitry” or “memory” as used herein, used in the context of a server platform may include, by way of example, a memory structure which may include at least one of a cache (such as a L1, L2, L3 or other level cache including last level cache), an instruction cache, a data cache, a first in first out (FIFO) memory structure, a last in first out (LIFO) memory structure, a time sensitive/time aware memory structure, a ternary content-addressable memory (TCAM) memory structure, a register file such as a nanoPU device, a tiered memory structure, a two-level memory structure, a memory pool, or a far memory structure, to name a few. According to embodiments, a “memory circuitry” as used herein may include any of the above non-cache memory structures carved out of a cache (e.g., carved out of a L1 cache) or separate from said cache. As used herein, “a memory of a server platform” may include one or more memory circuitries.

As used herein, an “update execution engine” or “execution engine” may, according to one example, corresponds to software, firmware, circuitry, or a combination of two or more of the same, the execution engine to implement an update of the FW components on the target server platform. The execution engine may be part of/running on the target server platform, on a host coupled to the target server platform, or distinct from both the server platform and the host. For example, the execution engine may be part of the data center manager.

“FW update metadata” as used herein may, in one example, refer to machine-readable FW update information that are to be used in executing a FW update action. Such information and its possible contents are described in further detail as the disclosure progresses.

As noted previously, a FW component update to interdependent server FW components is performed in the state of the art by using a mechanism to generate, express and process inter-component dependencies at various phases of the FW development, validation, and deployment process. In the state of the art, FW component compatibility and limitation information are communicated through written/verbal documentation, most commonly in what is known as “Release Notes,” that is, in human discernable form, such as in written form. These are, after being discerned by a human consumer, integrated into the deployment tool by the human consumer. Although software components have used dependency-based updates successfully, no such mechanism exists for FW or hardware updates.

Some embodiments recognize that the lack of machine-readable dependency-based updates to FW is primarily due to the lack of reliable inter-component dependency data.

Some embodiments address some disadvantages of the state of the art by embedding FW update metadata with the FW file, for example with the FW binary file, in a unified package.

An external agent can process this embedded metadata to resolve FW component dependencies for the target server (i.e., the server for which FW is to be updated) and determine the pre/post update actions required for the FW file in the unified package.

According to an embodiment, modular FW component (or “ingredient”) updates may be performed by using FW attribute information for respective FW components on the target server, such attribute information being extracted by a data center manager from FW update metadata, optionally from a unified FW update package or capsule. According to an embodiment, FW component dependencies may be verified and resolved by the DCM in order to, for example, determine the set of FW components that may be updated, and/or a relative order of such FW component updates. At least one of pre-update, update and post-update actions may further be enumerated in the FW update metadata for the corresponding FW component, and may be used by the DCM in executing a FW component update. Errors may be handled at respective stages for the update (e.g., pre-update, update and post-update).

Advantageously, some embodiments enable runtime modular FW component update to be executed based on FW update metadata to be used by FW update owners, such as DCMs, during such execution. In this manner, advantageously, the server for which updates are being executed may, according to an example, continue to execute workloads during the updates. Such metadata may optionally be carried within a FW update package or FW update capsule, sent in this form to the DCM.

A modular FW component update may be implemented according to some embodiments by introducing a mechanism to express FW attributes, inter-component dependencies and FW update actions in machine-readable format, to generate accurate FW component dependencies, and to optionally encapsulate the attributes, dependencies and update actions mentioned above in a unified FW update package or capsule for individual FW components to be updated.

Some embodiments advantageously provide metadata on a server FW component to be carried within a FW file along with the FW payload, such as a FW binary file, allowing modular FW component updates for individual FW components. In this manner, advantageously, a unified FW update package (metadata unified with FW payload) and related tools may be standardized, similar to some current software (SW) updates.

A unified FW update package (or FW update capsule) according to some embodiments embeds, for example in the form of metadata, information required to perform a FW component update in a modular fashion (e.g., a capsule per FW component to be updated). Such metadata may thus be beyond the update image of the FW file component being updated.

A modular runtime FW component update requires a mechanism to generate, express and process inter-component dependencies at various stages of the FW development, validation, and deployment process.

The input to the modular runtime FW update process may contain the following parts:
1. a FW payload, for example in the form of a binary version of the FW update package that contains the new FW;
2. FW update metadata, which may include:

a) FW attributes, including a list of versions of all components in the FW update file;

b) FW component dependencies, including a list of FW inter- and/or intra-dependencies that would need to be attested by the DCM to be able to perform the FW component update; and/or

c) an update formula, including:
(i) pre-update actions, including actions to prepare the server for FW component updates;
(ii) update actions, including actions to perform the FW component updates; and/or
(iii) post-update actions, including actions to restore the server to operation after the FW component updates; and
3. Package authentication data—A cryptographic verification of the above contents.

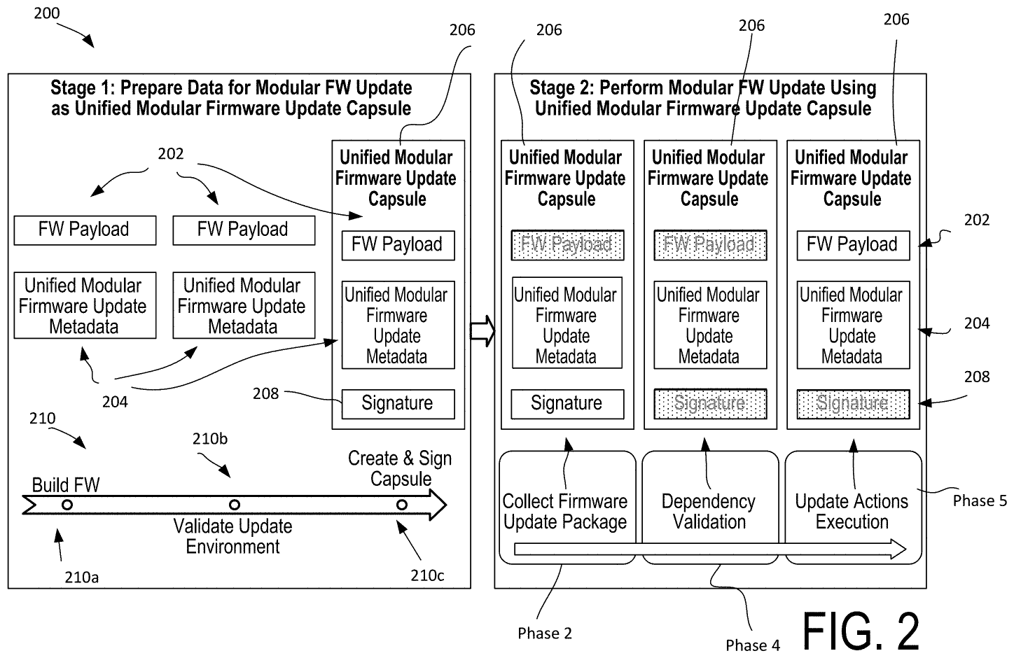

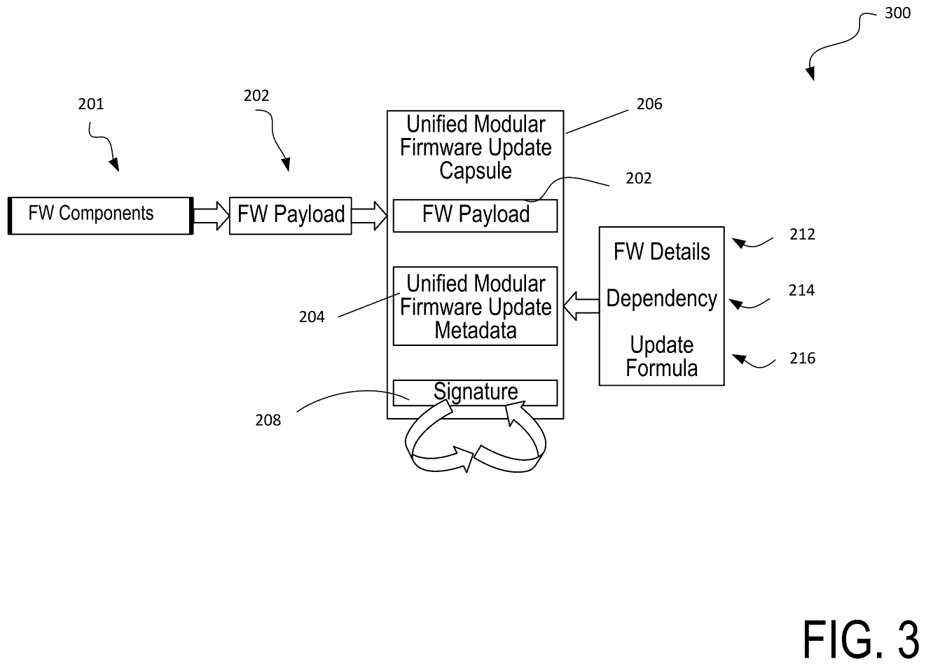

More details regarding a FW update package or FW update capsule will be provided below in the context of FIGS. 2 and 3.

Some example embodiments present a process for generating a unified FW update package or unified FW update capsule to include the above parts 1) through 3) above, although embodiments are not so limited, and include within their scope the generation of parts 1) through 3) in any form.

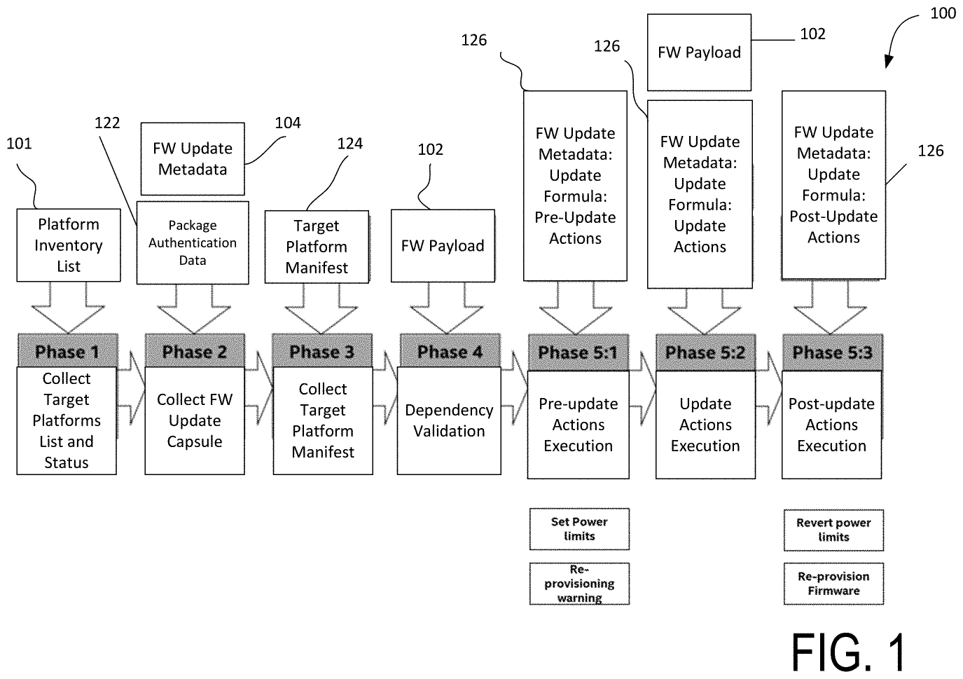

Some example embodiments present a process to perform a modular runtime FW update (presented at Stage 2 in FIG. 2 described in further detail below) using a methodology to apply the FW update by resolving inter-component and/or intra-component dependencies for FW components to be updated on a given server, and by processing FW specific pre- and/or post-update actions required to update the FW file image. An example FW update process according to some embodiments may include five phases, as will be shown and described in more detail in FIG. 1.

FIG. 1 shows a flow of a process 100 including phases 1 through 5:3 to implement a modular FW update on a server according to an embodiment. Individual phases of process 100 will be described in further detail below. The software tool to implement process 100 may include an DCM within a data center.

At phase 1, information on a target server (i.e., the server for which FW is to be updated) may be collected by a FW update capsule generator, for example by searching a server inventory list 101 to identify the target server set for applying the selected FW update.

The FW capsule update generator may include firmware or software to be executed by hardware, such as circuitry including one or more processors, during a build stage of the FW component.

The search may be performed by the FW update capsule generator by using searching criteria including server type, a current platform FW manifest, a runtime update capability, a runtime update compatibility with one or more FW component types requested by an update initiator. The FW component update may be performed serially for each server in a target set of server s, or it may be forked to perform parallel instances of the FW component update on multiple server s at the same time, or it may perform the FW component update on different target server s using a combination of serial and parallel implementation. In the event that the FW update capsule generator returns an empty list of target server s, and/or in the event that all server s have been already updated with FW component updates, the update process may be finalized, and an update report may be generated by the FW update capsule generator.

At phase 2, the DCM may collect a FW update package or FW update capsule. The FW update package may include a FW payload and correlated FW update metadata 104. The capsule may be stored and fetched from a central inventory location within a memory of the data center that includes the target server. The DCM may select the FW update package based selection parameters sent to it, or, it may select the FW update package based on performing a FW component dependency resolution operation. The dependency resolution operation may happen for example where update of FW component A may first require an update of FW component B because of a dependency resolution by the DCM regarding a different version of FW component B required to allow the update of FW component A. For example, if a ME update is executed and its dependency fails based on an incompatible BIOS version, the update process may be run next on a BIOS capsule and then go back to a ME update using the ME capsule.

Optionally, as a security measure, the DCM may process FW update package authentication data 122 to verify an integrity of the FW update package, including possibly verifying its source. If any of the operations of phase 2 fail, then entire update process may be discontinued and an update report generated.

At phase 3, the DCM may collect a target server manifest 124. In particular, in order to prepare for the a FW component dependency validation phase (phase 4 to be described below), the DCM may prepare target server configuration data as a target server manifest. The DCM may receive target configuration data through out-of-band from the target server, for example from its BMC, in-band form the host operating system, or through an existing telemetry generation process. The target server manifest may include, such as data on ME version, BIOS version, ME SVN version, etc. DCMs may collect some telemetry (CPU usage, FW versions, errors, etc.) which can be quickly reused instead of running an out-of-band or in-band process to obtain such data.

If generation of the target server manifest fails, the FW update process may be discontinued at the DCM and an update report generated.

At phase 4, the DCM may perform dependency validation. In particular, through implementing phase 4, the DCM may ensure that the FW payload 102 is compatible with a current FW configuration on the target server. For example, the FW payload may be a monolithic image, or a sub-module of a monolithic image. The ability to express and validate such dependencies may, in some examples provide a useful enabler for modular FW updates. In the event that the dependency validation phase fails at the DCM, the FW update process may be paused, and a new FW update process invoked to start a separate update that is based on a missing dependency determined during the dependency validation phase.

A sample usage of dependency validation is provided below:
let us assume that dependency processing rules in a FW update package for a FW component in the form of BIOS 1.2.3.8 is given as:
   BIOS_version >=1.2.3.6
   BMC_version >=3.3.3.2
   BMC_version <=3.3.3.4
some embodiments would include an DCM performing a dependency evaluation based on the above rules, and based on FW update metadata in the FW update package (or capsule) yields as follows:
   capsule.attribute.BIO S_version(“1.2.3.8”)≥Target_platform.BIOS_version
   capsule.attribute.BMC_version(“3.3.3.2”)≥Target_platform.BMC_version
   capsule.attribute.BMC_version(“3.3.3.4”)≤Target_platform.BMC_version

The DCM at phase 4 may process evaluation of capsule dependency rules one by one or in parallel, and, if any of the dependency validations fail, it may return a failure report, update the dependency process, where the failure report lists the failed dependency in its failure details.

At phase 5, including subphases 5:1, 5:2 and 5:3, the DCM may execute a FW update process, which may include communication between the DCM and the target server, such as the BCM and/or OS of the target server. In phase 5, in particular, the DCM may perform a FW update for a target server/FW update package pair determined through phases 1 through 4 described above. Phase 5 involves execution by the DCM of pre-update, update and post-update actions. The above advantageously enables fine grain control of runtime server state (e.g., setting max power limits). Thus, phase 5 advantageously enables FW updates at runtime (i.e., without reset) of the target server, an advantage for cloud service providers.

In particular, at subphase 5:1, the DCM executes pre-update actions. In the pre-update phase, the DCM may perform basic pre-update checks based on information 126 including the FW update metadata including a update formula. The pre-update may include one or more of:
1. verifying that no unwanted/unfriendly operations are running on the target server;
2. verifying that an initial state for executing a FW update is met (e.g., target server is not performing any reset operation; target server is within a predetermined power state, etc.);
3. implementing in the target server an initial state required for the FW update (e.g.

causing a power limit on the target server to be set to a predetermined value, etc.).

In particular, at subphase 5:2, the DCM may execute FW update actions. In this update subphase, the DCM may execute FW update processes based on information 126 including the FW update metadata and an update formula, and the FW payload 102. Such FW update processes may include one or more of:
1. sending a FW payload and corresponding FW update metadata (such as FW attributes) to an update execution engine (e.g., a BMC or an operating system). The execution engine may then perform the update operation, and cause the FW update metadata to be stored in order for the execution engine to handle any future FW downgrade requests; or
2. activating a FW component.

In subphase 5:2, failed FW update processes may be addressed by the DCM through execution of one or more post-update actions or through communication with an initiator of the update.

In particular, at subphase 5:3, the DCM may execute post-update actions. In this post-update subphase, the DCM may execute FW post-update processes based on information 126, and a result (i.e., success or failure) of the FW update processes that happened at subphase 5:2, which may be reported by the execution engine. The DCM may perform the post-update processes based on a post-update subprocess formula that is part of the FW update metadata. In this subphase 5:3, the DCM may also verify a functionality of the updated FW (i.e., verifying whether or not the updated FW functions on the target server).

The update phase 5 may finish with the DCM generating a FW update report which may include one or more of:
1. a FW update status result (i.e., failed or successful);
2. information about updated FW (e.g., previous revisions and new revisions);
3. results of the dependency validation phase 4;
4. results of any pre-update processes defined in the FW update metadata, the pre-update formula used, and results of pre-update actions taken, optionally including detailed information about any failure reason;
5. a result of an update operation reported by the execution engine;
6. a duration of the FW update operation at phase 5; or
7. results of performed post-update actions defined in the FW update metadata, the post-update formula used, and results of post-update actions taken, optionally including detailed information about any failure reason.

According to an embodiment, an external agent, such as a data center DCM, can process FW update metadata to resolve FW component dependencies for the target server and determine the pre/post update actions required for the FW file.

Advantageously, a modular update of individual FW components as described above limits the server downtime required for FW updates, and may allow verifying a server configuration while performing a resilient seamless update of the FW components.

Usage of a unified update capsule will now be described in more detail below. The unified update capsule may include, as one option, a unified FW update capsule or package as described above, although it may also be used independently of modularly updating FW components, for example by being used to update data storage and/or data creation flows. Therefore, although the below FIGS. 2-4 describe a FW update capsule (meaning a FW component update capsule or package as described above), it is to be understood that embodiments are not so limited.

Reference is now made to FIGS. 2 and 3, where FIG. 2 shows a flow 200 including two stages to perform modular FW updates using a unified modular FW update capsule, and where FIG. 3 shows a configuration 300 of a unified modular FW update capsule 206 according to an embodiment.

At a first stage or Stage 1 or the FW update capsule creation stage, referring for example to FIG. 2, the data for modular FW update may be prepared as a FW update capsule on a per FW component basis. Here, the information necessary for updating a FW component is gathered and encoded in a single package or capsule. Stage 1 may be performed during FW build, for example by a FW builder, which may then deliver a machine-readable medium storing one or more FW update capsules. The capsule creation flow 210 of FIG. 2 may involve a FW build stage, where data and code corresponding to the FW are generated at 210a, a update environment validation stage 210b, where the update environment is validated at 210b, and a capsule creation stage 210c, where the FW update capsule may be encoded as such, and where, optionally, a signature maybe be encoded into the FW update capsule, the signature to allow a DCM to verify an integrity and authenticity of the FW update capsule. The signature may be omitted however, especially where the FW updates are to be performed in a trusted environment, such as where the DCM is considered by the execution engine as a trusted source. With respect to validation of the update environment at 210b, this operation in the creation of the FW update capsule may involve encoding information regarding an OS, ME or BIOS of the server relevant to (e.g., that would accommodate, or that would be incompatible with) the FW update indicated in the FW update capsule. The validation of the update environment at 210b may further involve encoding information regarding the settings of the computing system relevant to (e e.g., that would accommodate, or that would be incompatible with) the FW update indicate in the FW update capsule. The DCM may test and verify for example that a FW update sought to be implemented is the correct update for a given target server. After encoding the FW update capsule, the DCM may send the same to be stored in memory for retrieval by the execution engine, or it may send the same to the execution engine either directly or indirectly.

At a second stage or Stage 2, or the FW update action execution stage, referring still for example to FIG. 2, the execution engine may, for individual FW components to be updated, collect (either by accessing it in memory, or by receiving it directly or indirectly from the DCM) corresponding FW update capsule. For a given FW update capsule, the execution engine may decode the update formula within the FW update capsule and execute the same to perform the FW update on a per component basis. Execution of update actions may involve collecting or receiving the FW update package, corresponding for example to phase 2 of FIG. 1, and then using the dependency information in the FW update metadata of the FW update capsule at to validate one or more dependencies of the FW component sought to be updated per capsule. The latter operation may correspond to phase 4 of FIG. 1. Thereafter, the DCM may execute update actions by implementing the FW component updates, which may correspond to phase 5 of FIG. 1. In FIG. 2, at Stage 2, the parts of the FW update capsule 206 that are not, at each one of phases 2, 4 and 5 shown in the figure, being used are shown as having been greyed out as compared with other parts of the FW update capsule.

A unified FW update capsule 206 (or FW update capsule/FW update package as referred to throughout the instance disclosure) may embed/include a FW payload 202 with the information required to perform the FW update in the form of FW update metadata 204. The ability to carry information on FW component dependency and on FW component update in the FW update capsule enables an external tool, such as a DCM, to safely update system component FW's in a modular way. A FW update capsule 206 according to some embodiments may be generated by a FW update capsule generator, which may be run on circuitry belonging to a firmware builder. The FW update capsule generator may be distinct from the DCM, or, it may, in one variation, be part of the DCM.

As explained above in the context of Stage 2 of FIG. 2, the FW update capsule 206 may include one or more of the following components:
1. a FW payload 202, which may include a FW update image, for example a binary FW update image, for a target server FW component. The format of these FW images can vary depending on the target server. The FW update image may correspond to an opaque block of data residing in kernel memory, and there may be an image per FW component to be updated as part of the FW payload 202. It may be associated to a unique image name which may include a search key, and an integer version number, which is also an opaque piece of information for the firmware subsystem. The FW payload 202 may be formed based on a given FW component.
2. unified modular FW update metadata 204 (or FW update metadata), which may contain information to perform all or part of the FW component update. The metadata may capture FW component attributes and inter-component dependency information in a machine-readable format, and optionally in a human readable format. In addition, the metadata may include information useful by an execution engine to perform the FW update on the FW components on the target server. Additional details on the FW update metadata are provided further below; or
3. a signature 208, which may correspond to data to establish the integrity and/or authenticity of the other two components. Authenticity may refer to messages (in this case, FW update metadata) received by the DCM being in fact sent by an expected message source. Integrity may refer to the message sent to the DCM in fact not having been changed en route to the DCM. The DCM may use the signature to verify the unified FW update capsule prior to processing its contents. The strength and type of cryptographic mechanisms used for generating the signature can vary according to application needs. The signature may be added by the FW update capsule generator at the end of capsule creation process.

Referring now to FIG. 3, the creation of a FW update capsule 206 at process 300 may optionally include the use of code 201 corresponding to FW to encode the FW payload 202, wherein the FW payload 202 is coded differently from the FW code 201.

Referring still to FIGS. 2 and 3, a FW update metadata 204 may include information to allow an execution engine to perform a runtime modular FW update without impacting the functionality of the target server during runtime.

Reference is now made to Table 1, which captures metadata which may be included in the FW update metadata 204 to allow an DCM to signal an execution engine to perform a module FW update based in part on the FW update metadata.

TABLE 1
unified modular FW update metadata components

| Capsule | |
|---|---|
| Section/Part | Section/Part Description |
| FW Attributes | This section contains information about |
| | FW contained within an associated FW |
| | update capsule. |
| Dependencies | This section contains information about |
| | dependencies that must be fulfilled to |
| | successfully perform update of FW |
| | contained within accompanying FW |
| | update capsule |
| FW Update | This section contains information about |
| Formula: Pre- | all actions that must be performed |
| update actions | before update of FW contained within |
| | accompanying FW update capsule |
| FW Update | This section contains information about |
| Formula: Update | all actions that must be performed |
| actions | during update of FW contained within |
| | accompanying FW update capsule |
| FW Update | This section contains information about |
| Formula: Post- | all actions that must be performed after |
| update actions | update of FW contained within |
| | accompanying FW update capsule |

FW Attributes:

The FW attributes 210 represent a part of the FW update capsule including, for individual FW components to be updated, FW component revision data, and/or versions of protocols and sub-components supported by that FW component. FW attributes 212 in a unified modular FW update manifest make possible execution of a FW update process according to some embodiments.

The FW attributes 212 may preferably include, for individual ones of the FW components, one or more of the following parts (or parameters):

1. FW version, including versions of individual ones of the FW components to be updated; or

2. external interfaces of individual ones of the FW components to be updated.

The FW attributes 212 may optionally include, for individual ones of the FW components, one or more of the following parts (or parameters):

1. a hash corresponding to configuration of the FW component;

2. versions of internal interfaces for the FW component; or

3. non-HW based embedded software version number (SVN) versioning for the FW component.

FW Dependencies:

FW dependencies 214 may correspond to information about dependencies of a FW component, which information may be sent to the DCM, for example from other server s. The information about dependencies for FW components to be updated may include software/FW revisions and protocol versions that must be fulfilled prior to updating the FW payload corresponding to the FW component. FW dependencies may be verified by the update DCM before sending the FW update capsule to the execution engine. If dependency verification fails for a given , then entire update process on that platform may be discontinued. FW dependencies correspond to code that is not to be executed during execution of the FW component that corresponds to those dependencies.

The FW dependencies 214 may preferably include, for individual ones of the FW components, one or more of the following parts (or parameters):

1. FW component versions used in validation; or

2. internal component versions.

The FW dependencies 214 may optionally include, for individual ones of the FW components, one or more of the following parts (or parameters):

1. external interfaces of the FW component;

2. configuration settings, which may correspond to configurations of the FW that may be altered during a lifetime of the FW operation, for example between an enabled state and a disabled state with a same executable FW binary (e.g., one version of a FW component's configuration may have boot guard enabled, while another version of the same FW component may have boot guard disabled);

3. server hardware (HW);

4. HW and SW SVNs;

5. system limitations with respect to FW components; or

6. server limitations with respect to FW components.

A sample usage of dependency validation is already provided above.

With respect to FW dependencies, the FW component may cause the server to perform compatibility tests of the FW component with the state of the server while the FW update is being made to the server. The compatibility test may include a test run of the FW on the server to see whether the FW as updated is still compatible with the server. Such actions may be implemented for example when persistent memory FW is updated on a server. In such a case, the DCM may either omit performing such a verification prior to executing update actions, or, it may perform such a verification on its end as well as a double-check on the compatibility test to be caused by the FW on the server.

FW Update Formula:

The FW update formula parameter 216 of the FW update capsule may include three distinct subsections, including a pre-update actions part, an update actions part, and a post-update actions part, respectively. The above three parts will now be described in further detail below.

Pre-Update Actions:

The pre-update action subpart of the FW update formula parameter 216 may contain information about operations to be completed before implementing the FW update. If any of defined pre-update actions fail for a given host, then the entire update process on that host may be discontinued.

The pre-update actions subpart of the FW update formula parameter 216 may optionally include, for individual ones of the FW components, information on one or more of the following parts (or parameters):

1. services impacted and actions to save/restore/verify such services—for example, certain services running on the target server may become unavailable during the update actions. For instance, during a BIOS or ME update, proxy services may become unavailable until the FW update is completed. In such an instance, the FW update formula may include information to let the BMC or OS of the server know regarding services that may not be available during the FW update execution. For instance, for a FW update, the update formula may include instructions to let a direct manager of a data center rack know of power settings needed during the FW update;

2. a warning regarding any re-provisioning requirement after the FW update has been completed—in certain instances, where an updated FW component is activated after its update, certain physical layer (PHY) system configurations of the service may be reset to a default state, or may be erased, such that PHY system configurations existing for the FW component before the update can no longer be used. In such a case, the FW update capsule may include information corresponding to a warning to reprovision the FW component that is to be updated. For example, power policies in a PHY system may be such that an updated FW component may not be compatible with it. In such a case, the FW update capsule may include information to reset the power policies of the PHY system of the server to a different, compatible power policy;

3. an update mechanism script;

4. a verification as to whether the FW component data is updated;

5. a reset or activation requirement; or

6. an error scenario indication and action on fail.

Update Actions:

The update actions subpart may contain information on a manner to perform an update process. Such information may include information regarding execution of a FW update, a manner of sending the unified modular FW update capsule to the execution engine, and a manner of triggering an update operation. The update process may not be executed without the information in the update actions subpart of the FW update capsule.

The update actions subpart may preferably include, for individual ones of the FW components, sending the new FW update information to the execution engine for implementation of the FW update on the target server.

The update actions subpart may optionally include, for individual ones of the FW components, information on activation of the new FW component on the server being updated.

Post-Update Actions

The post-update actions subpart may contain information on operations to be completed after completion of the update operation he the execution engine. Two types of actions may be defined as part of the post-update actions: operations performed after a successful update operation, and operations performed in the case of update failure.

The post-update actions subpart may optionally include, for individual ones of the FW components, one or more of the following parameters:

1. services impacted and actions to save/restore/verify such services;

2. a warning regarding any re-provisioning requirement;

3. an update mechanism script;

4. a verification as to whether the FW component data is updated;

5. a reset or activation requirement; or

6. an error scenario indication and action on fail.

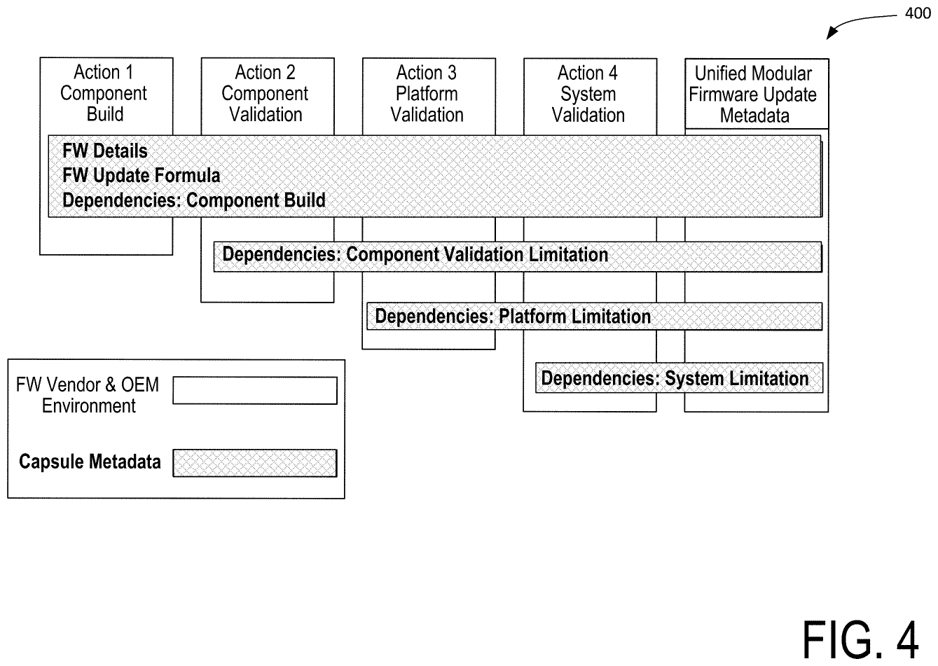

Reference is now made to FIG. 4, a unified modular FW update metadata generation process 400 according to an embodiment. Process 400 for the generation of FW update metadata may include a four action process spanning from component build at Action 1 to system validation at Action 4. The process 400 for the generation of a FW update metadata ensures that individual FW components to be updated are associated with comprehensive and up to date FW update metadata. Actions 1 through 4 are described in further detail below.

Action 1—FW Component Build:

Action 1 involves a FW component build process 210 where detailed information regarding a FW component and its update information is provided for inclusion into a FW update capsule. The FW update information may include one or more of:

1. FW details—including a list of FW details to be populated at a build phase;

2. a FW update formula, including a list of update actions to be created at build phase;

3. Dependencies at the build phase, which may include one or more of the following:
a) self and internal component versions and hashes;
b) external interfaces of the FW, including external interfaces of individual ones of the FW components to be updated;
c) server platform HW; or
d) HW and SW SVNs.

Action 2—FW Component Validation:

Action 2 involves a FW component validation process where detailed information regarding FW validation is provided for inclusion into a FW update capsule. The FW validation information may include information on dependencies, where the component validation phase is responsible for providing subset of dependencies on internal FW component limitations (e.g., management engine (ME) and BIOS versions).

Action 3—Platform Validation:

Action 3 involves a validation process where detailed information regarding validation is provided for inclusion into a FW update capsule. The validation information may include information on server component limitations, such as CPU version, PCI cards' FW versions, etc.

Action 4—System Validation:

Action 4 involves a system validation process where detailed information regarding system validation is provided for inclusion into a FW update capsule. The system validation information may include information on system limitations, such as the OS version being used.

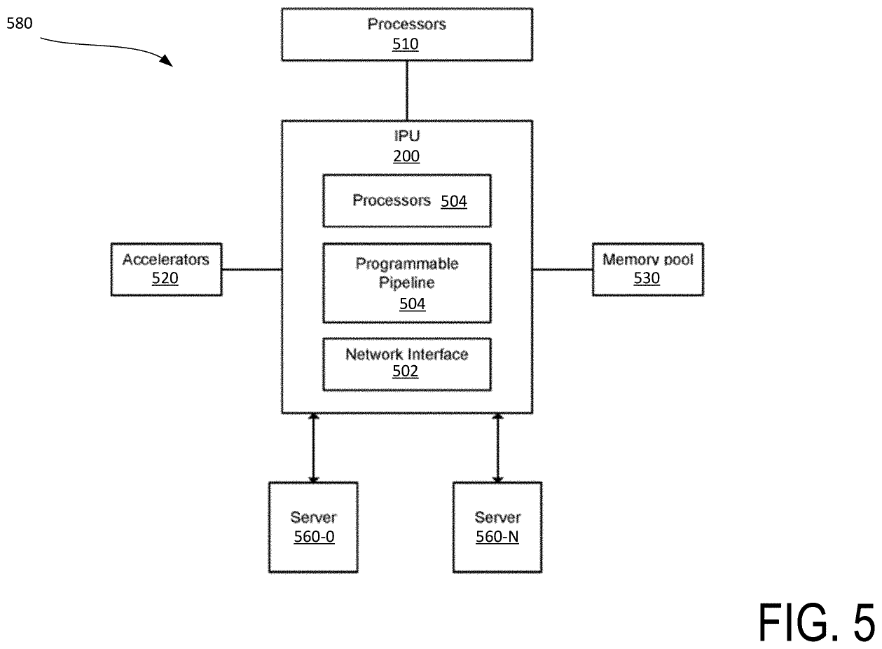

FIG. 5 depicts an example system 580 that may be used to implement some embodiments as described above in the context of FIGS. 1-4. In this system, IPU 500 manages performance of one or more processes using one or more of processors 504, processors 510, accelerators 520, memory pool 530, or servers 540-0 to 540-N, where N is an integer of 1 or more. In some examples, processors 504 of IPU 500 can execute one or more processes, applications, VMs, containers, microservices, and so forth that request performance of workloads by one or more of: processors 510, accelerators 520, memory pool 530, and/or servers 540-0 to 540-N. IPU 500 can utilize network interface 502 or one or more device interfaces to communicate with processors 510, accelerators 520, memory pool 530, and/or servers 540-0 to 540-N. IPU 500 can utilize programmable pipeline 504 to process packets that are to be transmitted from network interface 502 or packets received from network interface 502.

In some examples, configuration of programmable pipelines 404 can be programmed using a processor of processors 504 and operation of programmable pipelines 404 can continue during updates to software executing on the processor, or other unavailability of the processor, as a second processor of processors 504 provides connectivity to a host such as one or more of servers 560-0 to 560-N and the second processor can configure operation of programmable pipelines 404.

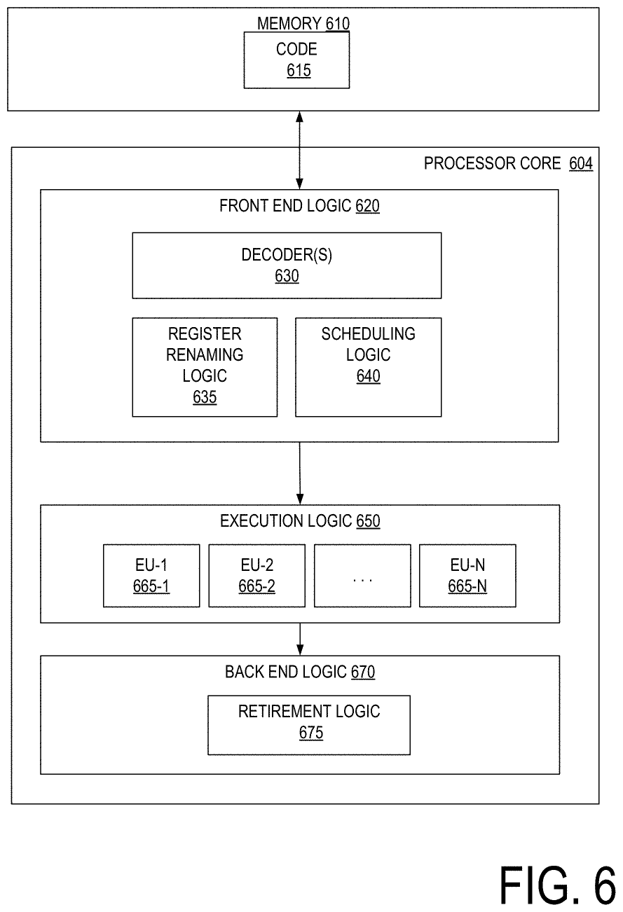

FIG. 6 is a block diagram of another exemplary system 600 including a processor core 604 to execute computer-executable instructions as part of implementing technologies described herein. The processor core 604 may perform any of the example processes according to some embodiments as described herein, for example as described in any of the Examples 45-66 and 89-103 below. The processor core 604 can be a core for any type of processor, such as a microprocessor, an embedded processor, a digital signal processor (DSP) or a network processor. The processor core 604 can be a single-threaded core or a multithreaded core in that it may include more than one hardware thread context (or “logical processor”) per core.

FIG. 6 also illustrates a memory 610 coupled to the processor 600. The memory 610 can be any memory described herein or any other memory known to those of skill in the art. The memory 610 can store computer-executable instruction 615 (code) executable by the processor core 604. For example, the memory 610 can store computer-executable instructions executable by the processor core to perform any of the example processes according to some embodiments as described herein, for example as described in any of the Examples 45-66 and 89-103 below

The processor core comprises front-end logic 620 that receives instructions from the memory 610. An instruction can be processed by one or more decoders 630. The decoder 630 can generate as its output a micro operation such as a fixed width micro operation in a predefined format, or generate other instructions, microinstructions, or control signals, which reflect the original code instruction. The front-end logic 620 further comprises register renaming logic 635 and scheduling logic 640, which generally allocate resources and queues operations corresponding to converting an instruction for execution.

The processor core 604 further comprises execution logic 650, which comprises one or more execution units (EUs) 665-1 through 665-N. Some processor core embodiments can include a number of execution units dedicated to specific functions or sets of functions. Other embodiments can include only one execution unit or one execution unit that can perform a particular function. The execution logic 650 performs the operations specified by code instructions. After completion of execution of the operations specified by the code instructions, back-end logic 670 retires instructions using retirement logic 675. In some embodiments, the processor core 604 allows out of order execution but requires in-order retirement of instructions. Retirement logic 670 can take a variety of forms as known to those of skill in the art (e.g., re-order buffers or the like).

The processor core 604 is transformed during execution of instructions, at least in terms of the output generated by the decoder 630, hardware registers and tables utilized by the register renaming logic 635, and any registers (not shown) modified by the execution logic 650. Although not illustrated in FIG. 6, a processor can include other elements on an integrated chip with the processor core 604. For example, a processor may include additional elements such as memory control logic, one or more graphics engines, I/O control logic and/or one or more caches.

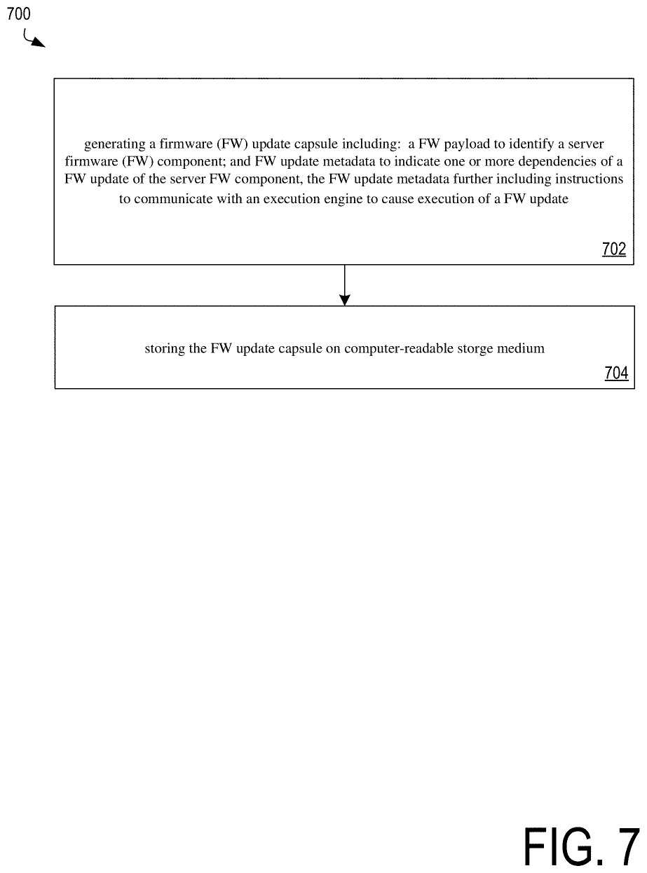

FIG. 7 depicts a process 700 according to one embodiment for generating a FW update capsule. The process 700 at operation 702 includes generating a firmware (FW) update capsule including: a FW payload to identify a firmware (FW) component of a server of a data center; and FW update metadata to indicate one or more dependencies of a FW update of the FW component, the FW update metadata further including instructions to communicate with an execution engine to cause execution of a FW update on the server. The process 700 at operation 704 includes storing the FW update capsule on a computer-readable storage medium.

Embodiments herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. It is noted that hardware, firmware and/or software elements may be collectively or individually referred to herein as “module,” or “logic.” A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores,” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. These terms are not necessarily intended as synonyms for another. For example, descriptions using the terms “connected” and/or “coupled” may indicate that two or more elements are in direct physical or electrical contact with another. The term “coupled,” however, may also mean that two or more elements are not in direct contact with another, but yet still co-operate or interact with another.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to be present. Additionally, conjunctive language such as the phrase “at least one of X, Y, and Z,” unless specifically stated otherwise, should also be understood to mean X, Y, Z, or any combination thereof, including “X, Y, and/or Z.”

Illustrative examples of the devices, systems, and methods disclosed herein are provided below. An embodiment of the devices, systems, and methods may include any one or more, and any combination of, the examples described below.

Flow diagrams as illustrated herein provide examples of sequences of various process actions. The flow diagrams can indicate operations to be executed by a software or firmware routine, as well as physical operations. In some embodiments, a flow diagram can illustrate the state of a finite state machine (FSM), which can be implemented in hardware and/or software. Although shown in a particular sequence or order, unless otherwise specified, the order of the actions can be modified. Thus, the illustrated embodiments should be understood only as an example, and the process can be performed in a different order, and some actions can be performed in parallel. Additionally, one or more actions can be omitted in various embodiments. Other process flows are possible.

Various components described herein can be a means for performing the operations or functions described. A component described herein includes software, hardware, or a combination of these. The components can be implemented as software modules, hardware modules, special-purpose hardware (e.g., application specific hardware, application specific integrated circuits (ASICs), digital signal processors (DSPs), etc.), embedded controllers, hardwired circuitry, and so forth.

### EXAMPLES

Additional examples of the presently described method, system, and device embodiments include the following, non-limiting implementations. Each of the following non-limiting examples may stand on its own or may be combined in any permutation or combination with any one or more of the other examples provided below or throughout the present disclosure.

Example 1 includes an apparatus of a data center, the apparatus including: a communication interface to couple the apparatus to one or more computing units; and one or more processors coupled to the communication interface, the one or more processors to: access first information corresponding to a firmware (FW) payload, the FW payload to identify a server FW component; access second information corresponding to FW update metadata, the FW update metadata to indicate one or more dependencies of a FW update of the server FW component; perform a validation of the one or more dependencies against corresponding server information; and in response to a determination of a success of the validation, communicate with an execution engine to cause execution of the FW update on the server.

Example 2 includes the subject matter of Example 1, wherein the one or more processors are to, in response to a determination of a failure of the validation, discontinue communication regarding the FW update.

Example 3 includes the subject matter of Example 1, wherein the one or more processors are to communicate with the server to cause execution of the FW update during runtime at the server.

Example 4 includes the subject matter of any one of Examples 1-3, wherein the execution engine is to be implemented on the server.

Example 5 includes the subject matter of any one of Examples 1-4, wherein the information on one or more dependencies includes information on at least one of a version of the server FW component or expected versions of other FW components of the server.

Example 6 includes the subject matter of Example 5, wherein the information on one or more dependencies further includes information on at least one of: an external interface of the server FW component; an indication of whether a configuration of the server FW component is enabled or disabled; a hardware of the server; version numbers of software or firmware components on the server; server limitations with respect to an update of the server FW component; or limitations with respect to an update of the server FW component of a computing system of the data center, the computing system including the server.

Example 7 includes the subject matter of Example 5, wherein the corresponding server information includes information on at least one of existing versions of the other FW components or runtime data regarding the server.

Example 8 includes the subject matter of Example 7, wherein the one or more processors are to receive the corresponding server information by way of an out-of-band communication from the server or of an in-band communication from a host of the data center.

Example 9 includes the subject matter of Example 7, wherein the one or more processors are to access the corresponding server information in a memory of the data center.

Example 10 includes the subject matter of Example 7, wherein the one or more processors are to collect telemetry information on the server, the corresponding server information corresponding to the telemetry information.

Example 11 includes the subject matter of any one of Examples 1-10, wherein the FW update metadata includes a FW update formula, the FW update formula including information to be used by the one or more processors to communicate with the execution engine to cause execution of the FW update.

Example 12 includes the subject matter of Example 11, wherein the FW update formula further includes information to cause activation of the server FW component on the server based on execution of the FW update.

Example 13 includes the subject matter of Example 11, wherein the FW update formula further includes pre-update information regarding a pre-update phase of the FW update, the pre-update information including information on at least one of: services to be impacted at the server by the FW updated; instructions on actions to be taken, based on the FW update, regarding settings of the server or of a manager of a rack including the server; a warning regarding a re-provisioning requirement after the FW update; a verification as to whether data of the server FW component is updated; a reset requirement for the server based on the FW update; an activation requirement for the server FW component based on the FW update; or instructions on actions to be taken in response to an error scenario based on the FW update.

Example 14 includes the subject matter of Example 11, wherein the FW update formula further includes pre-update information regarding a pre-update phase of the FW update, the pre-update information indicating pre-update actions including on at least one of: verifying that no unwanted operations are running on the server; verifying that an initial state of the server for executing the FW update is met; or implementing in the server an initial state required for the FW update.

Example 15 includes the subject matter of any one of Examples 1-14, wherein the FW update formula further includes post-update information regarding a post-update phase of the FW update, the post-update information including information on at least one of: services to be impacted at the server by the FW updated; a warning regarding a re-provisioning requirement after the FW update; a verification as to whether data of the server FW component is updated; a reset requirement for the server based on the FW update; an activation requirement for the server FW component based on the FW update; or instructions on actions to be taken in response to an error scenario based on the FW update.

Example 16 includes the subject matter of any one of Examples 1-15, wherein the one or more processors are to receive a FW update capsule including the FW payload and the FW update metadata.

Example 17 includes the subject matter of Example 16, wherein the FW update capsule further includes a signature part to be decoded by the server to at least one of authenticate or verify an integrity of the FW update capsule.

Example 18 includes the subject matter of Example 16, wherein the one or more processors are to receive the FW update capsule by accessing a memory of the data center.

Example 19 includes the subject matter of any one of Examples 1-18, the one or more processors to select the FW payload and the FW update metadata based on received selection parameters, or by based on performing a FW component dependency resolution operation.

Example 20 includes the subject matter of Example 19, wherein the server FW component is a second FW component, and wherein the server FW component dependency resolution operation includes, as a result of a validation of one or more dependencies of a first FW component, determining that the second FW component is to be updated prior to updating the firs FW component.

Example 21 includes the subject matter of any one of Examples 1-20, the one or more processors to generate a FW update report after execution of the FW update.

Example 22 includes the subject matter of Example 21, wherein the FW update report includes at least one of: a FW update status result; information on a revision history of the server FW component; results of the validation; pre-update information including at least one of: pre-update processes defined in the FW update metadata; pre-update actions implemented; results of pre-update actions implemented; or reasons for failures associated with pre-update actions implemented; a result of the FW update; a duration of the execution of the FW update; or post-update information including at least one of; post-update processes defined in the FW update metadata; post-update actions implemented; results of post-update actions implemented; or reasons for failures associated with post-update actions implemented.

Example 23 includes a non-transitory computer-readable storage medium comprising instructions stored thereon that, when executed by one or more processors of a data center, cause the one or more processors to perform operations including: accessing first information corresponding to a firmware (FW) payload, the FW payload to identify a server FW component; accessing second information corresponding to FW update metadata, the FW update metadata to indicate one or more dependencies of a FW update of the server FW component; performing a validation of the one or more dependencies against corresponding server information; and in response to a determination of a success of the validation, communicating with an execution engine to cause execution of the FW update on the server.

Example 24 includes the subject matter of Example 23, the operations including, in response to a determination of a failure of the validation, discontinuing communication regarding the FW update.

Example 25 includes the subject matter of Example 23, the operations including communicating with the server to cause execution of the FW update during runtime at the server.

Example 26 includes the subject matter of any one of Examples 23-25, wherein the execution engine is to be implemented on the server.

Example 27 includes the subject matter of any one of Examples 23-26, wherein the information on one or more dependencies includes information on at least one of a version of the server FW component or expected versions of other FW components of the server.

Example 28 includes the subject matter of Example 27, wherein the information on one or more dependencies further includes information on at least one of: an external interface of the server FW component; an indication of whether a configuration of the server FW component is enabled or disabled; a hardware of the server; version numbers of software or firmware components on the server; server limitations with respect to an update of the server FW component; or limitations with respect to an update of the server FW component of a computing system of the data center, the computing system including the server.

Example 29 includes the subject matter of Example 27, wherein the corresponding server information includes information on at least one of existing versions of the other FW components or runtime data regarding the server.

Example 30 includes the subject matter of Example 29, the operations including receiving the corresponding server information by way of an out-of-band communication from the server or of an in-band communication from a host of the data center.

Example 31 includes the subject matter of Example 29, the operations including accessing the corresponding server information in a memory of the data center.

Example 32 includes the subject matter of Example 29, the operations including collecting telemetry information on the server, the corresponding server information corresponding to the telemetry information.

Example 33 includes the subject matter of any one of Examples 23-32, wherein the FW update metadata includes a FW update formula, the FW update formula including information to be used for communicating with the execution engine to cause execution of the FW update.

Example 34 includes the subject matter of Example 33, wherein the FW update formula further includes information to cause activation of the server FW component on the server based on execution of the FW update.

Example 35 includes the subject matter of Example 33, wherein the FW update formula further includes pre-update information regarding a pre-update phase of the FW update, the pre-update information including information on at least one of: services to be impacted at the server by the FW updated; instructions on actions to be taken, based on the FW update, regarding settings of the server or of a manager of a rack including the server; a warning regarding a re-provisioning requirement after the FW update; a verification as to whether data of the server FW component is updated; a reset requirement for the server based on the FW update; an activation requirement for the server FW component based on the FW update; or instructions on actions to be taken in response to an error scenario based on the FW update.

Example 36 includes the subject matter of Example 33, wherein the FW update formula further includes pre-update information regarding a pre-update phase of the FW update, the pre-update information indicating pre-update actions including on at least one of: verifying that no unwanted operations are running on the server; verifying that an initial state of the server for executing the FW update is met; or implementing in the server an initial state required for the FW update.

Example 37 includes the subject matter of any one of Examples 23-36, wherein the FW update formula further includes post-update information regarding a post-update phase of the FW update, the post-update information including information on at least one of: services to be impacted at the server by the FW updated; a warning regarding a re-provisioning requirement after the FW update; a verification as to whether data of the server FW component is updated; a reset requirement for the server based on the FW update; an activation requirement for the server FW component based on the FW update; or instructions on actions to be taken in response to an error scenario based on the FW update.

Example 38 includes the subject matter of any one of Examples 23-37, the operations including receiving a FW update capsule including the FW payload and the FW update metadata.

Example 39 includes the subject matter of Example 38, wherein the FW update capsule further includes a signature part to be decoded by the server to at least one of authenticate or verify an integrity of the FW update capsule.

Example 40 includes the subject matter of Example 38, wherein the operations including receiving the FW update capsule by accessing a memory of the data center.

Example 41 includes the subject matter of any one of Examples 23-40, the operations including selecting the FW payload and the FW update metadata based on received selection parameters, or by based on performing a FW component dependency resolution operation.

Example 42 includes the subject matter of Example 41, wherein the server FW component is a second FW component, and wherein the server FW component dependency resolution operation includes, as a result of a validation of one or more dependencies of a first FW component, determining that the second FW component is to be updated prior to updating the firs FW component.

Example 43 includes the subject matter of any one of Examples 23-42, the operations including generating a FW update report after execution of the FW update.

Example 44 includes the subject matter of Example 21, wherein the FW update report includes at least one of: a FW update status result; information on a revision history of the server FW component; results of the validation; pre-update information including at least one of: pre-update processes defined in the FW update metadata; pre-update actions implemented; results of pre-update actions implemented; or reasons for failures associated with pre-update actions implemented; a result of the FW update; a duration of the execution of the FW update; or post-update information including at least one of; post-update processes defined in the FW update metadata; post-update actions implemented; results of post-update actions implemented; or reasons for failures associated with post-update actions implemented.

Example 45 includes a method to be performed by one or more processors of a data center, the method including: accessing first information corresponding to a firmware (FW) payload, the FW payload to identify a server FW component; accessing second information corresponding to FW update metadata, the FW update metadata to indicate one or more dependencies of a FW update of the server FW component; performing a validation of the one or more dependencies against corresponding server information; and in response to a determination of a success of the validation, communicating with an execution engine to cause execution of the FW update on the server.

Example 46 includes the subject matter of Example 45, further including, in response to a determination of a failure of the validation, discontinuing communication regarding the FW update.

Example 47 includes the subject matter of Example 45, further including communicating with the server to cause execution of the FW update during runtime at the server.

Example 48 includes the subject matter of any one of Examples 45-47, wherein the execution engine is to be implemented on the server.

Example 49 includes the subject matter of any one of Examples 45-48, wherein the information on one or more dependencies includes information on at least one of a version of the server FW component or expected versions of other FW components of the server.

Example 50 includes the subject matter of Example 49, wherein the information on one or more dependencies further includes information on at least one of: an external interface of the server FW component; an indication of whether a configuration of the server FW component is enabled or disabled; a hardware of the server; version numbers of software or firmware components on the server; server limitations with respect to an update of the server FW component; or limitations with respect to an update of the server FW component of a computing system of the data center, the computing system including the server.

Example 51 includes the subject matter of Example 49, wherein the corresponding server information includes information on at least one of existing versions of the other FW components or runtime data regarding the server.

Example 52 includes the subject matter of Example 51, further including receiving the corresponding server information by way of an out-of-band communication from the server or of an in-band communication from a host of the data center.

Example 53 includes the subject matter of Example 51, further including accessing the corresponding server information in a memory of the data center.

Example 54 includes the subject matter of Example 51, further including collecting telemetry information on the server, the corresponding server information corresponding to the telemetry information.

Example 55 includes the subject matter of any one of Examples 45-54, wherein the FW update metadata includes a FW update formula, the FW update formula including information to be used for communicating with the execution engine to cause execution of the FW update.

Example 56 includes the subject matter of Example 55, wherein the FW update formula further includes information to cause activation of the server FW component on the server based on execution of the FW update.

Example 57 includes the subject matter of Example 55, wherein the FW update formula further includes pre-update information regarding a pre-update phase of the FW update, the pre-update information including information on at least one of: services to be impacted at the server by the FW updated; instructions on actions to be taken, based on the FW update, regarding settings of the server or of a manager of a rack including the server; a warning regarding a re-provisioning requirement after the FW update; a verification as to whether data of the server FW component is updated; a reset requirement for the server based on the FW update; an activation requirement for the server FW component based on the FW update; or instructions on actions to be taken in response to an error scenario based on the FW update.

Example 58 includes the subject matter of Example 55, wherein the FW update formula further includes pre-update information regarding a pre-update phase of the FW update, the pre-update information indicating pre-update actions including on at least one of: verifying that no unwanted operations are running on the server; verifying that an initial state of the server for executing the FW update is met; or implementing in the server an initial state required for the FW update.

Example 59 includes the subject matter of any one of Examples 45-58, wherein the FW update formula further includes post-update information regarding a post-update phase of the FW update, the post-update information including information on at least one of: services to be impacted at the server by the FW updated; a warning regarding a re-provisioning requirement after the FW update; a verification as to whether data of the server FW component is updated; a reset requirement for the server based on the FW update; an activation requirement for the server FW component based on the FW update; or instructions on actions to be taken in response to an error scenario based on the FW update.

Example 60 includes the subject matter of any one of Examples 45-59, further including receiving a FW update capsule including the FW payload and the FW update metadata.

Example 61 includes the subject matter of Example 60, wherein the FW update capsule further includes a signature part to be decoded by the server to at least one of authenticate or verify an integrity of the FW update capsule.

Example 62 includes the subject matter of Example 60, wherein further including receiving the FW update capsule by accessing a memory of the data center.

Example 63 includes the subject matter of any one of Examples 45-62, further including selecting the FW payload and the FW update metadata based on received selection parameters, or by based on performing a FW component dependency resolution operation.

Example 64 includes the subject matter of Example 63, wherein the server FW component is a second FW component, and wherein the server FW component dependency resolution operation includes, as a result of a validation of one or more dependencies of a first FW component, determining that the second FW component is to be updated prior to updating the firs FW component.

Example 65 includes the subject matter of any one of Examples 45-64, further including generating a FW update report after execution of the FW update.

Example 66 includes the subject matter of Example 65, wherein the FW update report includes at least one of: a FW update status result; information on a revision history of the server FW component; results of the validation; pre-update information including at least one of: pre-update processes defined in the FW update metadata; pre-update actions implemented; results of pre-update actions implemented; or reasons for failures associated with pre-update actions implemented; a result of the FW update; a duration of the execution of the FW update; or post-update information including at least one of; post-update processes defined in the FW update metadata; post-update actions implemented; results of post-update actions implemented; or reasons for failures associated with post-update actions implemented.

Example 67 includes a computing system of a data center, the computing system including: a server including a plurality of computing units and a plurality of memory circuitries coupled to the computing units; and one or more processors to implement a data center manager to: access first information corresponding to a server firmware (FW) payload, the FW payload to identify a firmware (FW) component of the server; access second information corresponding to FW update metadata, the FW update metadata to indicate one or more dependencies of a FW update of the server FW component; perform a validation of the one or more dependencies against corresponding server information; and in response to a determination of a success of the validation, communicate with an execution engine to cause execution of the FW update on the server.

Example 68 includes the subject matter of Example 67, wherein the one or more processors are to, in response to a determination of a failure of the validation, discontinue communication regarding the FW update.

Example 69 includes the subject matter of Example 67, wherein the one or more processors are to communicate with the server to cause execution of the FW update during runtime at the server.

Example 70 includes the subject matter of any one of Examples 67-69, wherein the execution engine is to be implemented on the server.

Example 71 includes the subject matter of any one of Examples 67-70, wherein the information on one or more dependencies includes information on at least one of a version of the server FW component or expected versions of other FW components of the server.

Example 72 includes the subject matter of Example 71, wherein the information on one or more dependencies further includes information on at least one of: an external interface of the server FW component; an indication of whether a configuration of the server FW component is enabled or disabled; a hardware of the server; version numbers of software or firmware components on the server; server limitations with respect to an update of the server FW component; or limitations with respect to an update of the server FW component of a computing system of the data center, the computing system including the server.

Example 73 includes the subject matter of Example 71, wherein the corresponding server information includes information on at least one of existing versions of the other FW components or runtime data regarding the server.

Example 74 includes the subject matter of Example 73, wherein the one or more processors are to receive the corresponding server information by way of an out-of-band communication from the server or of an in-band communication from a host of the data center.

Example 75 includes the subject matter of Example 73, wherein the one or more processors are to access the corresponding server information in a memory of the data center.

Example 76 includes the subject matter of Example 73, wherein the one or more processors are to collect telemetry information on the server, the corresponding server information corresponding to the telemetry information.

Example 77 includes the subject matter of any one of Examples 67-76, wherein the FW update metadata includes a FW update formula, the FW update formula including information to be used by the one or more processors to communicate with the execution engine to cause execution of the FW update.

Example 78 includes the subject matter of Example 77, wherein the FW update formula further includes information to cause activation of the server FW component on the server based on execution of the FW update.

Example 79 includes the subject matter of Example 77, wherein the FW update formula further includes pre-update information regarding a pre-update phase of the FW update, the pre-update information including information on at least one of: services to be impacted at the server by the FW updated; instructions on actions to be taken, based on the FW update, regarding settings of the server or of a manager of a rack including the server; a warning regarding a re-provisioning requirement after the FW update; a verification as to whether data of the server FW component is updated; a reset requirement for the server based on the FW update; an activation requirement for the server FW component based on the FW update; or instructions on actions to be taken in response to an error scenario based on the FW update.

Example 80 includes the subject matter of Example 77, wherein the FW update formula further includes pre-update information regarding a pre-update phase of the FW update, the pre-update information indicating pre-update actions including on at least one of: verifying that no unwanted operations are running on the server; verifying that an initial state of the server for executing the FW update is met; or implementing in the server an initial state required for the FW update.

Example 81 includes the subject matter of any one of Examples 67-80, wherein the FW update formula further includes post-update information regarding a post-update phase of the FW update, the post-update information including information on at least one of: services to be impacted at the server by the FW updated; a warning regarding a re-provisioning requirement after the FW update; a verification as to whether data of the server FW component is updated; a reset requirement for the server based on the FW update; an activation requirement for the server FW component based on the FW update; or instructions on actions to be taken in response to an error scenario based on the FW update.

Example 82 includes the subject matter of any one of Examples 67-81, wherein the one or more processors are to receive a FW update capsule including the FW payload and the FW update metadata.

Example 83 includes the subject matter of Example 82, wherein the FW update capsule further includes a signature part to be decoded by the server to at least one of authenticate or verify an integrity of the FW update capsule.

Example 84 includes the subject matter of Example 82, wherein the one or more processors are to receive the FW update capsule by accessing a memory of the data center.

Example 85 includes the subject matter of any one of Examples 67-84, the one or more processors to select the FW payload and the FW update metadata based on received selection parameters, or by based on performing a FW component dependency resolution operation.

Example 86 includes the subject matter of Example 85, wherein the server FW component is a second FW component, and wherein the server FW component dependency resolution operation includes, as a result of a validation of one or more dependencies of a first FW component, determining that the second FW component is to be updated prior to updating the firs FW component.

Example 87 includes the subject matter of any one of Examples 67-86, the one or more processors to generate a FW update report after execution of the FW update.

Example 88 includes the subject matter of Example 87, wherein the FW update report includes at least one of: a FW update status result; information on a revision history of the server FW component; results of the validation; pre-update information including at least one of: pre-update processes defined in the FW update metadata; pre-update actions implemented; results of pre-update actions implemented; or reasons for failures associated with pre-update actions implemented; a result of the FW update; a duration of the execution of the FW update; or post-update information including at least one of; post-update processes defined in the FW update metadata; post-update actions implemented; results of post-update actions implemented; or reasons for failures associated with post-update actions implemented.

Example 89 includes a method to be performed at one or more processors, the method including: generating a firmware (FW) update capsule including: a FW payload to identify a firmware (FW) component of a server of a data center; and FW update metadata to indicate one or more dependencies of a FW update of the server FW component, the FW update metadata further including instructions to communicate with an execution engine to cause execution of a FW update on the server; and storing the FW update capsule on a non-transitory computer-readable storage medium.

Example 90 includes the subject matter of Example 89, the FW update metadata including instructions to: perform a validation of the one or more dependencies against corresponding server information; and in response to a determination of a success of the validation, communicate with the execution engine to cause execution of the FW update on the server.

Example 91 includes the subject matter of Example 90, the FW update metadata further including instructions to communicate with the server to cause execution of the FW update during runtime at the server.

Example 92 includes the subject matter of any one of Examples 89-91, wherein the information on one or more dependencies includes information on at least one of a version of the server FW component or expected versions of other FW components of the server.

Example 93 includes the subject matter of Example 92, wherein the information on one or more dependencies further includes information on at least one of: an external interface of the server FW component; an indication of whether a configuration of the server FW component is enabled or disabled; a hardware of the server; version numbers of software or firmware components on the server; server limitations with respect to an update of the server FW component; or limitations with respect to an update of the server FW component of a computing system of the data center, the computing system including the server.

Example 94 includes the subject matter of Example 93, wherein the corresponding server information includes information on at least one of existing versions of the other FW components or runtime data regarding the server.

Example 95 includes the subject matter of Example 94, the FW update metadata further including instructions to receive the corresponding server information by way of an out-of-band communication from the server or of an in-band communication from a host of the data center.

Example 96 includes the subject matter of Example 95, the FW update metadata further including instructions to access the corresponding server information in a memory of the data center.

Example 97 includes the subject matter of any one of Examples 90-96, wherein the FW update metadata includes a FW update formula, the FW update formula including information to be used to communicate with the execution engine to cause execution of the FW update.

Example 98 includes the subject matter of Example 97, wherein the FW update formula further includes information to cause activation of the server FW component on the server based on execution of the FW update.

Example 99 includes the subject matter of Example 98, wherein the FW update formula further includes pre-update information regarding a pre-update phase of the FW update, the pre-update information including information on at least one of: services to be impacted at the server by the FW updated; instructions on actions to be taken, based on the FW update, regarding settings of the server or of a manager of a rack including the server; a warning regarding a re-provisioning requirement after the FW update; a verification as to whether data of the server FW component is updated; a reset requirement for the server based on the FW update; an activation requirement for the server FW component based on the FW update; or instructions on actions to be taken in response to an error scenario based on the FW update.

Example 100 includes the subject matter of Example 99, wherein the FW update formula further includes pre-update information regarding a pre-update phase of the FW update, the pre-update information indicating pre-update actions including on at least one of: verifying that no unwanted operations are running on the server; verifying that an initial state of the server for executing the FW update is met; or implementing in the server an initial state required for the FW update.

Example 101 includes the subject matter of any one of Examples 89-100, wherein the FW update formula further includes post-update information regarding a post-update phase of the FW update, the post-update information including information on at least one of: services to be impacted at the server by the FW updated; a warning regarding a re-provisioning requirement after the FW update; a verification as to whether data of the server FW component is updated; a reset requirement for the server based on the FW update; an activation requirement for the server FW component based on the FW update; or instructions on actions to be taken in response to an error scenario based on the FW update.

Example 102 includes the subject matter of Example 89, wherein the FW update capsule further includes a signature part to be decoded by the server to at least one of authenticate or verify an integrity of the FW update capsule.

Example 103 includes the subject matter of Example 89, the FW update metadata further including instructions to receive the FW update capsule by accessing a memory of the data center.

Example 104 includes an apparatus including one or more processors to perform the method of any one of Examples 89-103.

Example 105 includes an apparatus including means for performing a method according to any one of Examples 45-66 and 89-103.

Example 106 includes a computer readable storage medium including code which, when executed, is to cause a machine to perform any of the methods of claims 45-66 and 89-103.

Example 107 includes a method to perform the functionalities of any one of Examples 45-66 and 89-103.

Example 108 includes a non-transitory computer-readable storage medium comprising instructions stored thereon, that when executed by one or more processors of a packet processing device, cause the one or more processors to perform the functionalities of any one of Examples 45-66 and 89-103.

Example 109 includes means to perform the functionalities of any one of Examples 45-66 and 89-103.

1. An apparatus including:
a communication interface to couple the apparatus to one or more computing units; and
one or more processors coupled to the communication interface, the one or more processors to:
access first information corresponding to a firmware (FW) payload, the FW payload to identify a server FW component;
access second information corresponding to FW update metadata, the FW update metadata to indicate one or more dependencies of a FW update of the server FW component;
perform a validation of the one or more dependencies against corresponding server information; and
in response to a determination of a success of the validation, communicate with an execution engine to cause execution of the FW update on the server.

2. The apparatus of claim 1, wherein the one or more processors are to, in response to a determination of a failure of the validation, discontinue communication regarding the FW update.

3. The apparatus of claim 1, wherein the one or more processors are to communicate with the server to cause execution of the FW update during runtime at the server.

4. The apparatus of claim 1, wherein the execution engine is to be implemented on the server.

5. The apparatus of claim 1, wherein the information on one or more dependencies includes information on at least one of a version of the server FW component or expected versions of other FW components of the server.

6. The apparatus of claim 5, wherein the information on one or more dependencies further includes information on at least one of:
an external interface of the server FW component;
an indication of whether a configuration of the server FW component is enabled or disabled;
a hardware of the server;
version numbers of software or firmware components on the server;
server limitations with respect to an update of the server FW component; or
limitations with respect to an update of the server FW component of a computing system of the data center, the computing system including the server.

7. The apparatus of claim 5, wherein the corresponding server information includes information on at least one of existing versions of the other FW components or runtime data regarding the server.

8. A non-transitory computer-readable storage medium comprising instructions stored thereon that, when executed by one or more processors of a data center, cause the one or more processors to perform operations including:
accessing first information corresponding to a firmware (FW) payload, the FW payload to identify a server FW component;
accessing second information corresponding to FW update metadata, the FW update metadata to indicate one or more dependencies of a FW update of the server FW component;
performing a validation of the one or more dependencies against corresponding server information; and
in response to a determination of a success of the validation, communicating with an execution engine to cause execution of the FW update on the server.

9. The storage medium of claim 8, the operations including receiving the corresponding server information by way of an out-of-band communication from the server or of an in-band communication from a host of the data center.

10. The storage medium of claim 8, the operations including accessing the corresponding server information in a memory of the data center.

11. The storage medium of claim 8, the operations including collecting telemetry information on the server, the corresponding server information corresponding to the telemetry information.

12. The storage medium of claim 8, wherein the FW update metadata includes a FW update formula, the FW update formula including information to be used for communicating with the execution engine to cause execution of the FW update.

13. The storage medium of claim 12, wherein the FW update formula further includes information to cause activation of the server FW component on the server based on execution of the FW update.

14. The storage medium of claim 12, wherein the FW update formula further includes pre-update information regarding a pre-update phase of the FW update, the pre-update information including information on at least one of:
services to be impacted at the server by the FW updated;
instructions on actions to be taken, based on the FW update, regarding settings of the server or of a manager of a rack including the server;
a warning regarding a re-provisioning requirement after the FW update;
a verification as to whether data of the server FW component is updated;
a reset requirement for the server based on the FW update;
an activation requirement for the server FW component based on the FW update; or
instructions on actions to be taken in response to an error scenario based on the FW update.

15. A method to be performed by one or more processors of a data center, the method including:
accessing first information corresponding to a firmware (FW) payload, the FW payload to identify a server FW component;
accessing second information corresponding to FW update metadata, the FW update metadata to indicate one or more dependencies of a FW update of the server FW component;
performing a validation of the one or more dependencies against corresponding server information; and
in response to a determination of a success of the validation, communicating with an execution engine to cause execution of the FW update on the server.

16. The method of claim 15, wherein the FW update metadata includes a FW update formula, the FW update formula including information to be used for communicating with the execution engine to cause execution of the FW update, the FW update formula further including pre-update information regarding a pre-update phase of the FW update, the pre-update information indicating pre-update actions including on at least one of:
verifying that no unwanted operations are running on the server;
verifying that an initial state of the server for executing the FW update is met; or implementing in the server an initial state required for the FW update.

17. The method of claim 16, wherein the FW update formula further includes post-update information regarding a post-update phase of the FW update, the post-update information including information on at least one of:
services to be impacted at the server by the FW updated;
a warning regarding a re-provisioning requirement after the FW update;
a verification as to whether data of the server FW component is updated;
a reset requirement for the server based on the FW update;
an activation requirement for the server FW component based on the FW update; or
instructions on actions to be taken in response to an error scenario based on the FW update.

18. The method of claim 15, further including receiving a FW update capsule including the FW payload and the FW update metadata.

19. A computing system of a data center, the computing system including:
a server including a plurality of computing units and a plurality of memory circuitries coupled to the computing units; and
one or more processors to implement a data center manager to:
access first information corresponding to a server firmware (FW) payload, the FW payload to identify a firmware (FW) component of the server;
access second information corresponding to FW update metadata, the FW update metadata to indicate one or more dependencies of a FW update of the server FW component;
perform a validation of the one or more dependencies against corresponding server information; and
in response to a determination of a success of the validation, communicate with an execution engine to cause execution of the FW update on the server.

20. The system of claim 19, wherein the one or more processors are to receive a FW update capsule including the FW payload and the FW update metadata, wherein the FW update capsule further includes a signature part to be decoded by the server to at least one of authenticate or verify an integrity of the FW update capsule.
